(19) United States
(12) Patent Application Publication
(10) Pub. No.: US 2018/0336879 A1
(43) Pub. Date: Nov. 22, 2018

(54) INFORMATION PROVIDING DEVICE AND INFORMATION PROVIDING METHOD

(71) Applicant: TOYOTA JIDOSHA KABUSHIKI KAISHA, Toyota-shi (JP)

(72) Inventors: Keiko NAKANO, Kawasaki-shi (JP); Chihiro INABA, Yokohama-shi (JP); Michio OKADA, Toyohashi-shi (JP)

(73) Assignee: TOYOTA JIDOSHA KABUSHIKI KAISHA, Toyota-shi (JP)

(21) Appl. No.: 15/977,065

(22) Filed: May 11, 2018

(30) Foreign Application Priority Data
May 19, 2017 (JP) 2017-099799

(51) Int. Cl. G10L 13/04; G08G 1/0962

(52) U.S. Cl. CPC G10L 13/043; G06T 13/80; G08G 1/0962

(57) ABSTRACT

An information providing device is provided, which provides a user with information on driving circumstances of a vehicle by using a plurality of characters as interfaces. The information providing device includes: a collection unit configured to determine information to be provided to the user, based on information acquired by one or more sensing units installed in the vehicle; an utterance generation unit configured to generate a content of utterance to be given by each of the characters, based on the determined information; and an output unit configured to cause each of the characters to give the utterance in order to provide the user with the information.

### BACKGROUND OF THE INVENTION

### Field of the Invention

The present invention relates to an information providing device.

### Description of the Related Art

In the field of automobiles, systems that sense information on driving circumstances and give cautions or advice to drivers have been known. For example, Japanese Patent Application Laid-open No. 2011-070575 discloses an information presenting device for a vehicle capable of effectively presenting information to a driver.

Meanwhile, in recent years, devices or systems that provide information via personal assistants have been proposed. In the field of automobiles as well, information provision performed only by displays or speakers have been replaced by personal assistants (such as communication robots).

For example, a system in which a robot in a size installable in a vehicle is provided in an automobile and information on safe driving is provided by voice, or the like has been discussed. When information on safety is provided via a personal assistant like this, a user is allowed to easily accept advice and contribute to safe driving.

Meanwhile, a system that gives advice to a driver based on a result of sensing driving circumstances faces the problem of a false positive event (i.e., the system detects the occurrence of an event although the event has not actually occurred) or a false negative event (i.e., the system is not allowed to detect the occurrence of an event although the event has actually occurred). However, a relevance ratio and a reproduction ratio have a trade-off relationship, and thus it is not easy to search for an appropriate value. In addition, when the system is biased to either the relevance ratio or the reproduction ratio, reliability that the driver feels about the system reduces.

### SUMMARY OF THE INVENTION

The present invention has been made in consideration of the above problems and has an object of preventing reduction in reliability resulting from false discrimination in a device that provides information on driving circumstances of a vehicle.

An information providing device according to an embodiment of the present invention is a device providing a user with information on driving circumstances of a vehicle by using a plurality of characters as interfaces.

Specifically, the information providing device includes: a collection unit configured to determine information to be provided to the user, based on information acquired by one or more sensing units installed in the vehicle; an utterance generation unit configured to generate a content of utterance to be given by each of the characters, based on the determined information; and an output unit configured to cause each of the characters to give the utterance in order to provide the user with the information.

The plurality of characters may be physical interface devices such as robots or virtual characters displayed on a screen. The information providing device according to the embodiment of the present invention causes each of a plurality of characters to separately give utterance to provide a user with information.

The collection unit is a unit configured to determine information to be provided to the user based on information acquired from a sensing unit installed in a vehicle. The sensing unit may be any unit so long as it collects information on the traveling of the vehicle. For example, the sensing unit may be a speed sensor, an acceleration sensor, an ultrasonic sensor, a distance measurement sensor, a GPS unit, or the like. In addition, the sensing unit is not necessarily a sensor that acquires a physical amount. For example, the sensing unit may be a camera, a microphone, or the like, or may be a unit that acquires data on traffic from an outside.

The information to be provided to the user may be any information such as “a traffic signal ahead is lighting up in red,” “running on a narrow road,” “pedestrians are abundant,” and “a bicycle is approaching,” which are relevant to driving circumstances, an environment outside the vehicle, or the like. Such information may be directly generated from information acquired by the sensing unit (for example, sensor information), or may be generated via a discriminator or the like.

The utterance generation unit is a unit configured to generate a content of utterance to be given by each of characters based on information to be provided. For example, information such as “a traffic signal ahead is lighting up in red” is expressed in an utterance form by a plurality of characters. For example, the utterance generation unit generates utterance such as “A traffic signal is lighting up in red,” “I know,” and “Absolutely” for each of the characters.

Note that utterance to be given by a character may not necessarily make sense by itself. For example, “It is red” and “Absolutely” may be combined together to make sense. In addition, utterance to be given by a character may not necessarily affirm information. For example, as opposed to “A traffic signal is lighting up in red,” “Really?” representing a negative opinion may be included.

According to the configuration, it is possible to convey information to a user as “an own opinion of each of a plurality of characters.” Thus, the conveyance of information without relying on a simple standard is allowed. In addition, even if a false positive event or a false negative event occurs, a user understands that the occurrence of such an event results from the individuality of each character (for example, “a character gives much advice but makes many mistakes,” “a character is usually calm but gives advice with high accuracy,” or the like). Therefore, it is possible to prevent reduction in the reliability of an entire system.

In addition, the utterance generation unit may generate the utterance for each of the characters by using two or more of an object associated with the information to be provided to the user, a status of the object, and an expression of response.

By configuring utterance with an object (for example, a traffic signal, a pedestrian, a bicycle, a lane, or the like), the status of the object (for example, the content of the traffic signal that is lighting up, the presence or absence of the object, the size of a value, or the like), and a corresponding expression of response (for example, a positive or negative response, asking a question, or the like), it is possible to cause a plurality of characters to give a variety of utterance.

Moreover, when the plurality of characters output same information, the utterance generation unit may cause each of the characters to utter a different content.

By causing different characters to utter different contents when the different characters output the same information, it is possible to express the information richly.

Further, the information providing device according to the embodiment of the present invention may further include a determination unit configured to determine, for each of the characters, whether the information is to be positively conveyed to the user by using a different standard, and the utterance generation unit may generate the utterance to be given by each of the characters, based further on a content of a determination made by the determination unit.

Furthermore, the determination unit may cause each of the characters to have a different probability at which the information is to be positively conveyed to the user.

By setting a different standard as to whether information is to be positively conveyed to the user for each of characters, it is possible to cause each of the characters to have an individuality such as “a character that positively provides information but makes many mistakes” and “a character that is careful about providing information.”

Furthermore, the collection unit may acquire a first value representing a probability at which the information is correct, and the determination unit may determine whether each of the characters is to positively convey the information to the user, based on the first value and a second value set for each of the characters.

The determination of the first value, i.e., the determination of a probability at which generated information is correct is allowed based on, for example, the accuracy of a sensor, a likelihood output from a discriminator, or the like. The first value may be held in advance according to the type of information, or may be dynamically generated.

In addition, the second value is a value defining the characteristics of a character. The second value may be, for example, a value defining the degree to which a character positively conveys information.

For example, information may be more positively conveyed as the first value and the second value are greater in size. According to the configuration, it is possible to create a character that positively provides information but often conveys misinformation when the second value is made greater in size. On the other hand, it is possible to create a character that rarely conveys misinformation but rarely provides information (often overlooks an event) when the second value is made smaller in size.

Note that the present invention may be specified as an information providing device including at least part of the above units. In addition, the present invention may also be specified as an information providing method performed by the information providing device. The above processing or the units may be freely combined together to be performed unless technological contradictions arise.

According to an embodiment of the present invention, it is possible to prevent reduction in reliability resulting from false discrimination in a device that provides information on driving circumstances of a vehicle.

### BRIEF DESCRIPTION OF THE DRAWINGS

FIG. 1 is a system configuration diagram of an information providing device according to a first embodiment;

FIG. 2 shows an example of the screen of an information output unit;

FIG. 3 shows an example of teaching information generated by a teaching information generation unit;

FIGS. 4A to 4C are diagrams for describing a method for generating opinion parameters;

FIG. 5 shows an example of a conversation pattern table;

FIGS. 6A to 6C show an example of utterance generated for each of characters; and

FIG. 7 is a flowchart of processing performed by the information providing device according to the first embodiment.

### DESCRIPTION OF THE EMBODIMENTS

### First Embodiment

An information providing device according to a first embodiment is a system that generates information for giving advice about driving operations based on data (hereinafter called sensor information) collected from a plurality of sensors provided in a vehicle and provides a user with the generated information.

The generated information may be any information so long as it is generated based on information acquired from sensors or the like provided in the vehicle. As such, the information is, for example, information on the teaching (attention calling) of road signs or signals, the presence or absence of neighboring pedestrians or bicycles, the presence or absence of obstacles, or the like, but any information other than these information items may be included so long as it is generated based on events presumable from the sensor information. In addition, the information to be provided to the user is not limited to the attention calling information but may be advice about driving or the like. For example, the information to be provided to the user may be information read from road signs to be informed or information urging the user to use headlights, wipers, a defroster, or the like according to circumstances outside the vehicle.

<System Configuration>

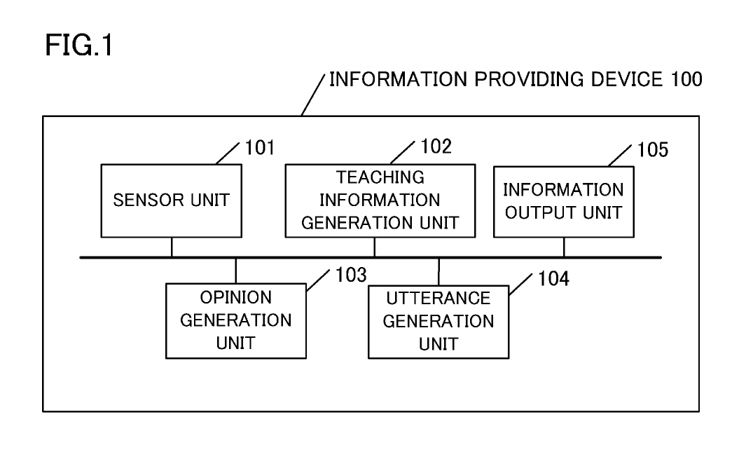

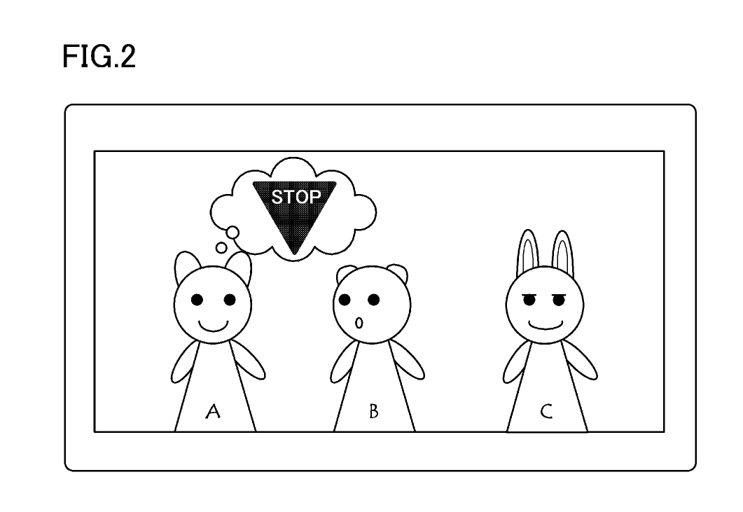

FIG. 1 is a system configuration diagram of the information providing device according to the first embodiment. An information providing device 100 according to the first embodiment is a device that generates voice data and an image to be provided to a user based on collected information and outputs the generated voice data and the image via a virtual character. In the embodiment, a plurality of characters displayed on a screen as shown in FIG. 2 give utterance by voice to provide information.

The information providing device 100 is typically a small computer such as a mobile computer, a mobile phone, a smart phone, and an in-vehicle terminal. The information providing device 100 may be configured as an information processing device having a central processing unit (CPU), a main storage unit, and a sub-storage unit. Each means shown in FIG. 1 functions when a program stored in the sub-storage unit is loaded into the main storage unit and performed by the CPU. Note that all or part of functions shown in FIG. 1 may be performed using an exclusively-designed circuit.

The information providing device 100 includes a sensor unit 101, a teaching information generation unit 102, an opinion generation unit 103, an utterance generation unit 104, and an information output unit 105.

The sensor unit 101 represents a plurality of sensors installed in a vehicle. The sensor unit 101 may include, for example, a speed sensor, an acceleration sensor, a yaw rate sensor, a steering angle sensor, a radar, a global positioning system (GPG) module, or the like. Note that information (hereinafter called sensor information) output from the sensors may be any information so long as it is relevant to the traveling of the vehicle (for example, information on the status of the vehicle, an environment around the vehicle, or the like). For example, the sensor information may be information on a speed, an acceleration, a steering angle, the current position of the own vehicle, the position of an obstacle, or the like. In addition, the sensor information may be information on a driver's living-body. Further, the sensor information is not necessarily information expressing a physical amount. For example, the sensor information may be an image taken by a camera, or the like.

The teaching information generation unit 102 is means for generating information (hereinafter called teaching information) to be provided to a passenger of the vehicle based on the acquired sensor information. In the embodiment, the teaching information generation unit 102 generates the teaching information using data (for example, a table) in which the relationship between the sensor information and the teaching information is described.

Note that when the sensor information is image data, voice data, or the like, the teaching information generation unit 102 may perform processing after converting the data into feature amounts.

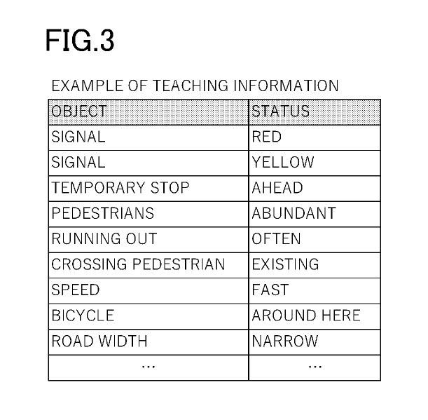

FIG. 3 shows an example of the teaching information in the embodiment. The teaching information in the embodiment includes two types of information, i.e., an “object” and an “object status.”

The teaching information generation unit 102 generates, for example, “a traffic signal ahead is lighting up in red” as the teaching information based on acquired sensor information.

The opinion generation unit 103 is means for determining the content of an opinion to be expressed by a character based on the teaching information generated by the teaching information generation unit 102. In the embodiment, the opinion generation unit 103 determines “whether each character is to positively convey the teaching information.” A detailed method will be described later.

The utterance generation unit 104 is means for generating the content of utterance to be given by each character based on the content determined by the opinion generation unit 103. A detailed method will be described later.

The information output unit 105 is means for providing the user (the passenger of the vehicle) with information. In the embodiment, the information output unit 105 displays an image via a display device such as a liquid crystal display and outputs a voice via a speaker.

The information output unit 105 has the function of synthesizing voices together based on the contents of the utterance acquired from the utterance generation unit 104 and reproducing synthesized voices as the utterance of the characters. In addition, the information output unit 105 has the function of generating an image corresponding to each character. Moreover, the information output unit 105 has the function of animating each character based on the contents of the utterance or other conditions.

<Characteristics Parameters>

Next, a description will be given in detail of the processing performed by the opinion generation unit 103.

A probability at which the teaching information generated by the teaching information generation unit 102 (that is, the teaching information to be provided to the user by the device) is correct depends on the performance of the sensors or the like provided in the sensor unit 101. That is, the low accuracy of the sensors or the like results in a decrease in the accuracy of the provided information, whereby the user may be distrustful of the entire device.

In view of the problem, the information providing device 100 according to the embodiment is configured to determine “whether a plurality of characters are to positively convey the teaching information” using different standards and cause each of the characters to separately give utterance to provide the information.

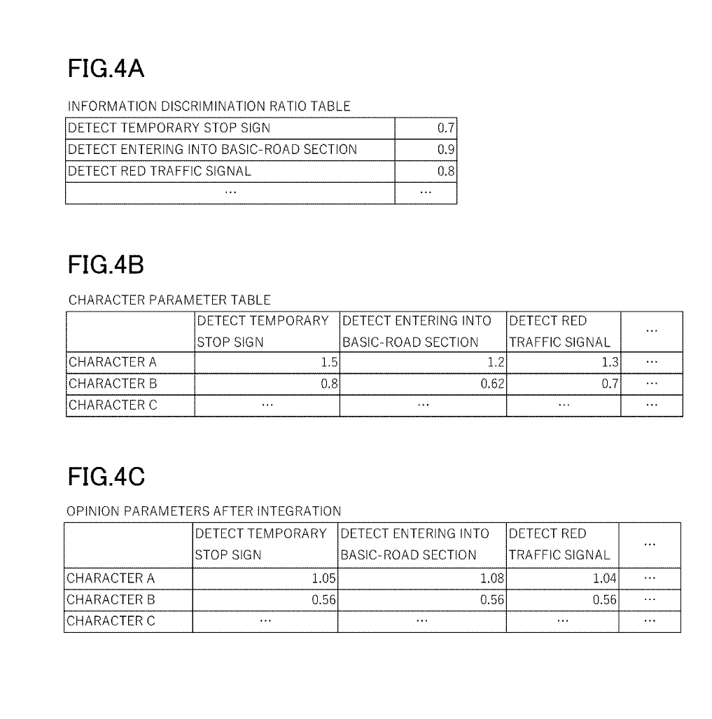

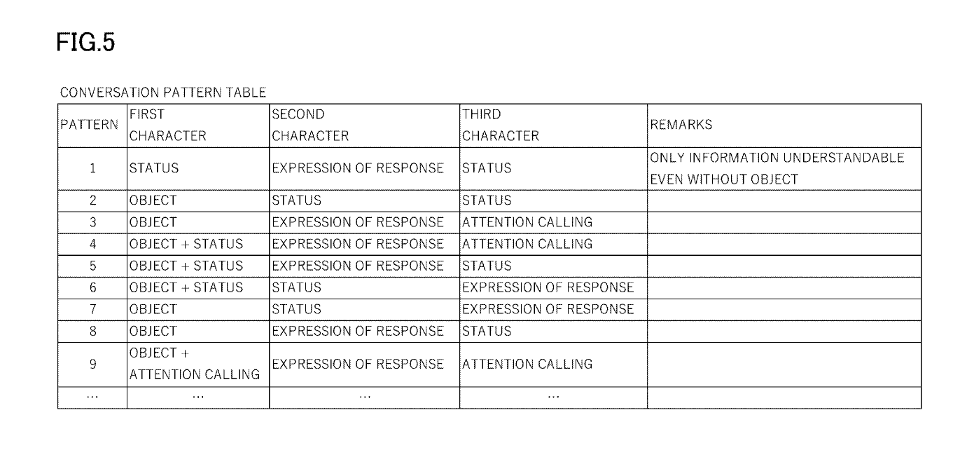

A description will be given in further detail of the processing with reference to FIGS. 4A to 4C.

FIG. 4A is a table showing a discrimination ratio (i.e., a probability at which an object is correctly discriminable, which is hereinafter called an information discrimination ratio) for each teaching information. For example, it is shown by the example of FIG. 4A that a temporary stop sign is correctly detectable at a probability of 70%, and that a red signal is correctly detectable at a probability of 80%.

In addition, FIG. 4B is a table showing characteristics (hereinafter called characteristics parameters) as to whether the teaching information is to be positively conveyed by numeric values for each character. It is shown by the table that corresponding characters having greater characteristics parameters tend to more positively convey corresponding teaching information.

In the embodiment, the opinion generation unit 103 stores the tables shown in FIGS. 4A and 4B in advance and integrates the two information (the information discrimination ratios and the characteristics parameters) together to determine whether the teaching information is to be positively conveyed. Note that the opinion generation unit 103 multiplies the information discrimination ratios by the characteristics parameters in the first embodiment. FIG. 4C is a table showing values (hereinafter called opinion parameters) after the multiplication. In the embodiment, the teaching information is to be positively conveyed at a probability of 100% when the opinion parameters have values of 1.0 or more. In addition, the teaching information is to be positively conveyed at probabilities shown by the opinion parameters when the opinion parameters have values less than 1.0. In the example of FIG. 4C, when there is teaching information “a temporary stop sign exists,” a character B is to positively convey the information to the user at a probability of 56%.

According to the above configuration, it is possible to perform control as to whether each character is to positively provide teaching information or not. For example, it is possible to create “characters (sensitive characters) that positively provide information” by increasing values of characteristics parameters. On the other hand, it is possible to create “characters (insensitive characters) that are careful about providing information” by decreasing the values of the characteristics parameters. In addition, it is possible to create balanced characters by setting the values of the characteristics parameters at intermediate values.

That is, each character may have a different attitude about providing information. Therefore, even if a false positive event or a false negative event occurs, the user understands that the occurrence of such an event results from the individualities of the characters. Therefore, it is possible to prevent reduction in the reliability of an entire system.

Note that a case in which “information is not to be positively conveyed” includes both a case in which each character gives utterance denying teaching information and a case in which each character does not express his/her own opinion.

<Conversation Patterns>

As described above, the information providing device according to the embodiment determines whether a plurality of characters are to positively convey the teaching information using different standards. For example, it is assumed in a pattern that a character A “cautions about a temporary stop sign,” a character B “cautions about the temporary stop sign,” and a character C “gives no utterance.”

Meanwhile, utterance becomes monotonous when a plurality of characters convey information having the same content. In view of this problem, the utterance generation unit 104 defines a plurality of conversation patterns and performs control so that each character gives utterance having a different content.

FIG. 5 shows an example of a table in which the conversation patterns are defined. As described above, the teaching information includes an “object” and an “object status.” In this example, the utterance generation unit 104 combines together four types of information items including an “expression of response” and “attention calling” to determine the contents of utterance to be given by three characters.

For example, when a pattern 2 is selected, the first character teaches an object and the second and third characters teach an object status. In addition, when a pattern 4 is selected, the first character teaches an object and an object status, the second character gives an expression of response, and the third character calls for an attention.

Note that the n-th character represents a “character that is to give utterance in the n-th place among characters that are to positively convey the teaching information.” That is, when there is a character that is not to positively convey the teaching information, the utterance generation unit 104 skips the character to generate utterance. A corresponding character refrains from positively conveying the teaching information. For example, such a character may not express an opinion (does not give utterance) or may show a sign of having no interest. Alternatively, the character may give utterance to ask a question about utterance given by another character.

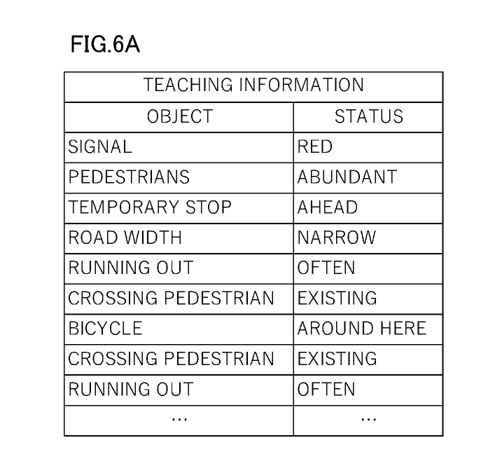

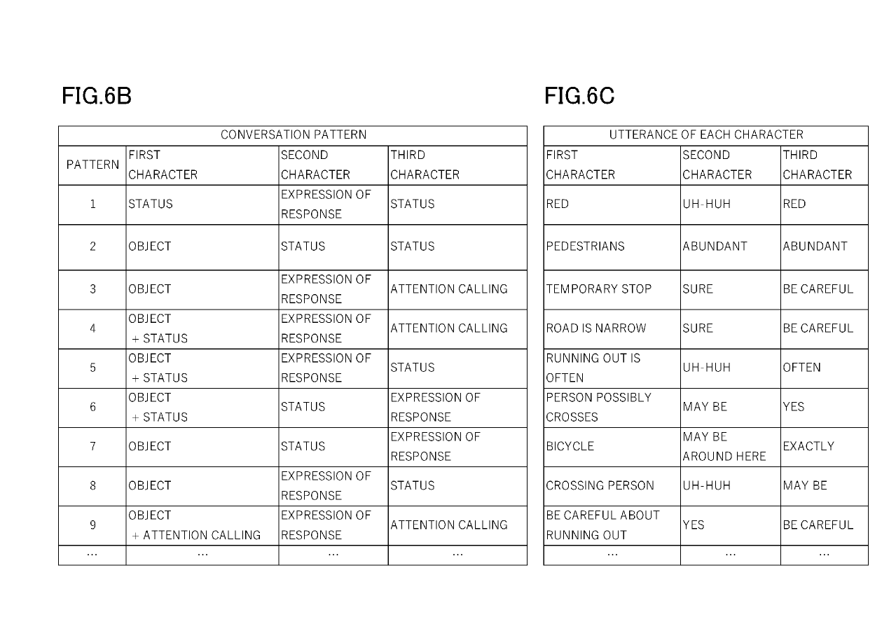

FIG. 6A to FIG. 6C are diagrams showing an example of the contents of utterance generated by combining together the teaching information and the conversation pattern table shown in FIG. 5.

For example, when the above pattern 2 and the teaching information “pedestrians are abundant” are combined together, the characters A, B, and C utter “Pedestrians,” “Abundant,” and “Abundant,” respectively. When only the characters A and B are to positively convey the teaching information, the characters A and B may utter “Pedestrians,” and “Abundant,” respectively, while the character C may utter “Really?”

For example, when the above pattern 4 and the teaching information “a road width is narrow” are combined together, the characters A, B, and C utter “Road is narrow,” “Sure,” “Be careful,” respectively. When only the characters A and C are to positively convey the teaching information, the characters A and C may utter “Road is narrow” and “Sure,” respectively, while the character B may give “no utterance.”

<Processing Flowchart>

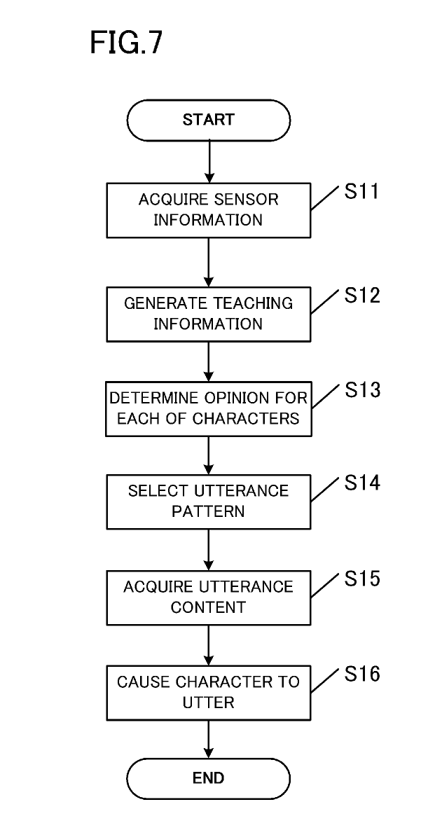

Next, a description will be given of processing performed by each means shown in FIG. 1 with reference to FIG. 7 representing a processing flowchart. The processing shown in FIG. 7 is periodically performed during the traveling of a vehicle.

First, in step S11, the sensor unit 101 collects sensor information. The sensor unit 101 may include a plurality of sensors.

Next, in step S12, the teaching information generation unit 102 generates teaching information based on the acquired sensor information. The teaching information may be generated using, for example, a table or the like in which the sensor information and the teaching information are associated with each other as described above, or may be generated using machine learning or the like.

Then, in step S13, the opinion generation unit 103 determines an opinion for each character. As described above, an opinion for each character is determined based on a value (opinion parameter) calculated by multiplying an information discrimination ratio by a characteristics parameter. For example, a random actual number (random number) is generated in the range of 0 or more and 1.0 or less. When the opinion parameter is smaller than the generated value, a character may positively convey teaching information. The processing is performed for all the characters.

Next, in step S14, the utterance generation unit 104 selects an utterance pattern. Note that the utterance pattern may be randomly selected from defined patterns, or the defined patterns may be narrowed down to select the utterance pattern. For example, a specific pattern may be preferentially selected or eliminated according to the characteristics of the teaching information. For example, in the case of FIG. 5, a pattern 1 may be made selectable only when an object is a traffic signal (since information on colors is generally relevant to the traffic signal). In addition, only a pattern not including attention calling may be selected when there is no need to call for an attention like a case in which information is to be simply provided. Moreover, the patterns may be narrowed down according to whether an object is a static one (for example, an object such as a road width that does not change) or a dynamic one (for example, an object such as a pedestrian that may change).

Next, in step S15, the utterance generation unit 104 acquires an utterance content for each character. The conversation patterns and the utterance contents may be stored in advance in association with each other, or the utterance contents may be dynamically generated based on the conversation patterns.

Then, in step S16, the information output unit 105 generates and outputs images and voices to cause each character to give utterance. On this occasion, the information output unit 105 also generates the movement of each character and generates corresponding continuous images to create animation. As movement patterns, patterns corresponding to the utterance contents, the type of the teaching information, or the like may be used among those defined in advance.

As described above, the information providing device according to the first embodiment conveys teaching information via a plurality of characters having different characteristics parameters. According to the configuration, each character may have a different attitude about teaching information. That is, since deviation in a relevance ratio or a reproduction ratio is likely to be recognized as the characteristics of each character, it is possible to prevent reduction in the reliability of an entire system.

In addition, since a plurality of characters give utterance having different contents, it is possible to convey information with freshness and a good tempo.

### Second Embodiment

In the first embodiment, information on the accuracy of the teaching information as shown in FIG. 4A is stored in advance to be used. However, the accuracy of the teaching information fluctuates depending on circumstances in an actual road environment and is not constant. In view of the problem, the reliability of the teaching information is acquired on a case-by-case basis in a second embodiment.

In the second embodiment, the teaching information generation unit 102 has one or more discriminators and performs the discrimination of an event and the generation of the teaching information with a plurality of sensor information items as inputs. The discriminators may be a plurality of single-class discriminators or multiple-class discriminators. In addition, results output from a plurality of discriminators may be integrated together to generate the teaching information.

In the embodiment, the discriminators output and transmit likelihoods (probability) together with discrimination results to the opinion generation unit 103. Then, the opinion generation unit 103 generates opinion parameters based on the acquired likelihoods and characteristics parameters. That is, the likelihoods acquired from the discriminators are used instead of information discrimination ratios in the first embodiment.

According to the second embodiment, since the generation of opinion parameters using likelihoods that fluctuate according to circumstances is allowed, it is possible to provide information with higher accuracy.

### MODIFIED EXAMPLE

The above embodiments are given only as examples, and the present invention may be appropriately modified and performed without departing from its spirit.

For example, characters are displayed on the screen in the description of the embodiments but may be replaced by physical devices such as communication robots. For example, robots that have voice output means such as a speaker and a movable portion such as an actuator and serve as an interface with a user may be used.

In addition, a characteristics parameter is defined for each character in the description of the embodiments but may not be necessarily defined. For example, opinion parameters may be generated using standards other than characteristics parameters (i.e., a determination is made as to whether the teaching information is to be positively conveyed using the standards other than the characteristics parameters). In addition, a method other than the method shown in FIGS. 4A to 4C may be used to generate opinion parameter.

Moreover, a conversation pattern table is provided so that one of a plurality of conversation patterns to be used is selected in the description of the embodiments, but a conversation pattern may not be necessarily selected. For example, a specific conversation pattern may be fixed, or the utterance content of each character may be determined on a case-by-case basis using means other than such a table. In this case, the utterance contents of characters may be adjusted so as not to overlap each other.

Further, an example of providing information on the status of a vehicle or an environment around the vehicle is given in the description of the embodiments, but information other than such information may be provided. For example, advice or the like about safe driving may be given based on a result obtained by sensing driver's living-body information.

What is claimed is:

1. An information providing device providing a user with information on driving circumstances of a vehicle by using a plurality of characters as interfaces, the information providing device comprising:
a collection unit configured to determine information to be provided to the user, based on information acquired by one or more sensing units installed in the vehicle;
an utterance generation unit configured to generate a content of utterance to be given by each of the characters, based on the determined information; and
an output unit configured to cause each of the characters to give the utterance in order to provide the user with the information.

2. The information providing device according to claim 1, wherein
the utterance generation unit is further configured to generate the utterance for each of the characters by using two or more of: an object associated with the information to be provided to the user, a status of the object, and an expression of response.

3. The information providing device according to claim 1, wherein,
the utterance generation unit is further configured to cause each of the characters to utter a different content when the plurality of characters output same information.

4. The information providing device according to claim 1, further comprising:
a determination unit configured to determine, for each of the characters, whether the information is to be positively conveyed to the user by using different standards respectively, wherein
the utterance generation unit is further configured to generate the utterance to be given by each of the characters, based further on a content of a determination made by the determination unit.

5. The information providing device according to claim 4, wherein
the determination unit is further configured to cause each of the characters to have a different probability at which the information is to be positively conveyed to the user.

6. The information providing device according to claim 5, wherein
the collection unit is further configured to acquire a first value representing a probability at which the information is correct, and
the determination unit is further configured to determine whether each of the characters is to positively convey the information to the user, based on the first value and a second value set for each of the characters.

7. An information providing method performed by an information providing device providing a user with information on driving circumstances of a vehicle by using a plurality of characters as interfaces, the information providing method comprising:
determining information to be provided to the user, based on information acquired by one or more sensing units installed in the vehicle;
generating a content of utterance to be given by each of the characters, based on the determined information; and
causing each of the characters to give the utterance in order to provide the user with the information.

8. A non-transitory computer-readable storage medium storing a program which, when run by a computer, causes the computer to execute the method according to claim 7.
